(19) United States
(12) Patent Application Publication
(10) Pub. No.: US 2012/0159319 A1
(43) Pub. Date: Jun. 21, 2012

(54) METHOD FOR SIMULATING A PAGE TURN IN AN ELECTRONIC DOCUMENT

(76) Inventor: Jean-Baptiste MARTINOLI, St-Anaclet-de-Lessard (CA)

(21) Appl. No.: 13/164,399

(22) Filed: Jun. 20, 2011

Related U.S. Application Data
(60) Provisional application No. 61/423,990, filed on Dec. 16, 2010.

(51) Int. Cl. G06F 3/14

(52) U.S. Cl. 715/273

(57) ABSTRACT

A method is disclosed for simulating a page turn in an electronic document comprising a plurality of pages having a given width, the method comprising displaying a first page; detecting a signal indicative of a page turn of the first page in a given direction; displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page; when said first width is equal to zero, displaying a second image adjacent to said first image, said second image comprising a corresponding second image portion having a width substantially smaller than the width of the second portion, said second image for displaying a second page, said width of said corresponding second image portion increasing until reaching said given width to thereby simulate a page turn.

### CROSS REFERENCE TO RELATED APPLICATIONS

This application claims the benefit of U.S. Ser. No. 61/423,990, filed on Dec. 16, 2010, which is incorporated in its entirety herein by reference.

### FIELD OF THE INVENTION

The invention relates to touch screens. More precisely, the invention pertains to a method for simulating a page turn in an electronic document.

### BACKGROUND

A touch screen can be broadly defined as a display screen sensitive to the touch of a finger or stylus. Such display screens are now widely used on smart phones, tablet computers, ATM machines, retail point-of-sale terminals, car navigation systems, medical monitors, industrial control panels, etc.

Touch screens are of great interest for many reasons. For instance, one reason is that the user interface may be designed and changed in an infinite way. Also in the case where no keyboard is connected, the touch screen can be used to display a keyboard which will be used to interact with a processing device having the touch screen. Touch screens are also of great interest for accepting handwriting, graphics and finger movements.

An electronic document is often comprised of many pages.

Being able to provide an interactive way to turn pages in a touch screen is of great advantage and is desirable for many reasons.

For instance, this would be of great advantage for increasing a user experience.

Unfortunately, prior art methods for turning pages in an electronic document suffer from many drawbacks.

For instance, in some prior art methods, pages are displayed one next to the others. In such embodiment, a user may browse pages by moving a displayed page outside the screen to view an adjacent page. This is far from mimicking a real page turn.

In another embodiment disclosed in US Patent Application N° 2010/0175018, a method has been disclosed for turning pages. In such embodiment, a virtual page turn curls a lifted portion of the page to progressively reveal a back side of the page while progressively revealing a front side of a subsequent page. A lifted portion of the page is given an increased transparency that allows the back side of the page to be viewed through the front side of the page.

Unfortunately such method requires processing resources for enabling the back side of the page to be viewed through the front side of the page.

There is a need for a method that will overcome at least one of the above-identified drawbacks. Features of the invention will be apparent from review of the disclosure, drawings and description of the invention below.

### BRIEF SUMMARY

In accordance with an embodiment, there is disclosed a method for simulating a page turn in an electronic document comprising a plurality of pages having a given width, the method comprising displaying a first page; detecting a signal indicative of a page turn of the first page in a given direction; displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page; and when the first width is equal to zero, displaying a second image adjacent to the first image, the second image comprising a corresponding second image portion having a width substantially smaller than the width of the second portion, the second image for displaying a second page, the width of the corresponding second image portion increasing until reaching the given width to thereby simulate a page turn.

In an embodiment, the signal indicative of a page turn comprises a given gesture.

In yet another embodiment, the given gesture comprises a linear finger movement.

In another embodiment, the signal indicative of a page turn comprises a given key pressed on a keyboard.

In yet another embodiment, the signal indicative of a page turn of the first page in a given direction is provided by another application.

In accordance with another embodiment, there is disclosed a method for simulating a page motion in an electronic document comprising a plurality of pages, the method comprising displaying a first page; detecting a signal indicative of a page motion of the first page in a given direction; displaying an image having a first portion having a first width and comprising the first page and a second portion having a second width substantially smaller than the first width and comprising a selected visible portion of a third page located behind the first page and wherein the width of the first portion decreases while the width of the second portion increases such that the sum of the first width and the second width remains constant and further wherein the selected visible portion of the third page is a portion of the third page unmasked by a projection of the first portion of the first page.

In an embodiment, the signal indicative of a page motion comprises a given gesture.

In yet another embodiment, the given gesture comprises a linear finger movement.

In another embodiment, the signal indicative of a page motion comprises a given key pressed on a keyboard.

In yet another embodiment, the signal indicative of a page motion of the first page in a given direction is provided by another application.

In accordance with an embodiment, there is disclosed a computer-readable storage medium storing computer-executable instructions which, when executed, cause a computing device to perform a method for simulating a page turn in an electronic document comprising a plurality of pages, the method comprising displaying a first page; detecting a signal indicative of a page turn of the first page in a given direction; displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page; and when the first width is equal to zero, displaying a second image adjacent to the first image, said second image comprising a corresponding second image portion having a width substantially smaller than the width of the second portion, the second image for displaying a second page, the width of the corresponding second image portion increasing until reaching said given width to thereby simulate a page turn.

In accordance with another aspect of the invention, there is disclosed a computing device, comprising a display device; one or more central processing units; a memory comprising an application; and one or more programs, wherein the one or more programs are stored in the memory and configured to be executed by the one or more central processing units, the one or more programs including instructions for displaying a first page; instructions for detecting a signal indicative of a page turn of the first page in a given direction; instructions for displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page and instructions for displaying a second image adjacent to the first image when the first width is equal to zero, the second image comprising a corresponding second image portion having a width substantially smaller than the width of the second portion, the second image for displaying a second page, the width of the corresponding second image portion increasing until reaching the given width to thereby simulate a page turn.

In yet another aspect of the invention, there is provided a computer-readable storage medium storing computer-executable instructions which, when executed, cause a computing device to perform a method for simulating a page motion in an electronic document comprising a plurality of pages, the method comprising displaying a first page; detecting a signal indicative of a page motion of the first page in a given direction and displaying an image having a first portion having a first width and comprising the first page and a second portion having a second width substantially smaller than the first width and comprising a selected visible portion of a third page located behind the first page and wherein the width of the first portion decreases while the width of the second portion increases such that the sum of the first width and the second width remains constant and further wherein the selected visible portion of the third page is a portion of the third page unmasked by a projection of the first portion of the first page.

In accordance with another aspect of the invention, there is disclosed a computing device comprising a display device; one or more central processing units; a memory comprising an application; and one or more programs, wherein the one or more programs are stored in the memory and configured to be executed by the one or more central processing units, the one or more programs including: instructions for displaying a first page; instructions for detecting a signal indicative of a page motion of the first page in a given direction and instructions for displaying an image having a first portion having a first width and comprising the first page and a second portion having a second width substantially smaller than the first width and comprising a selected visible portion of a third page located behind the first page and wherein the width of the first portion decreases while the width of the second portion increases such that the sum of the first width and the second width remains constant and further wherein the selected visible portion of the third page is a portion of the third page unmasked by a projection of the first portion of the first page.

An advantage of the method disclosed is that a user may have an idea of what is displayed on the second page and on the third page before the page turn of the first page is completed.

Another advantage of the method disclosed is that the simulation of the page turn is performed with a limited amount of processing resources compared to prior art methods. Benefits deriving from the use of a limited amount of processing resources may include increased battery life, lower computing device temperature, increased responsiveness of the computing device, and increased speed for scanning pages.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for simulating a page turn in an electronic document comprising a plurality of pages.

FIG. 2a is a diagram which shows a first embodiment of a user interface in which a signal indicative of a page turn has been detected.

FIG. 2b is a diagram which shows a second embodiment of a user interface in which a signal indicative of a page turn has been detected.

FIG. 2c is a diagram which shows a third embodiment of a user interface in which a signal indicative of a page turn has been detected.

FIG. 2d is a diagram which shows a fourth embodiment of a user interface in which a signal indicative of a page turn has been detected.

FIG. 2e is a diagram which shows a fifth embodiment of a user interface in which a signal indicative of a page turn has been detected.

FIG. 2f is a diagram which shows a sixth embodiment of a user interface in which a signal indicative of a page turn has been detected.

FIG. 2g is a diagram which shows a seventh embodiment of a user interface in which a signal indicative of a page turn has been detected.

FIG. 2h is a diagram which shows a eighth embodiment of a user interface in which a signal indicative of a page turn has been detected.

FIG. 2i is a diagram which shows a ninth embodiment of a user interface in which a signal indicative of a page turn has been detected.

FIG. 3 is a block diagram which shows an embodiment of an apparatus in which the method for simulating a page turn in an electronic document may be implemented.

FIG. 4 is a flowchart which shows another embodiment of a method for simulating a page turn in an electronic document comprising a plurality of pages.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

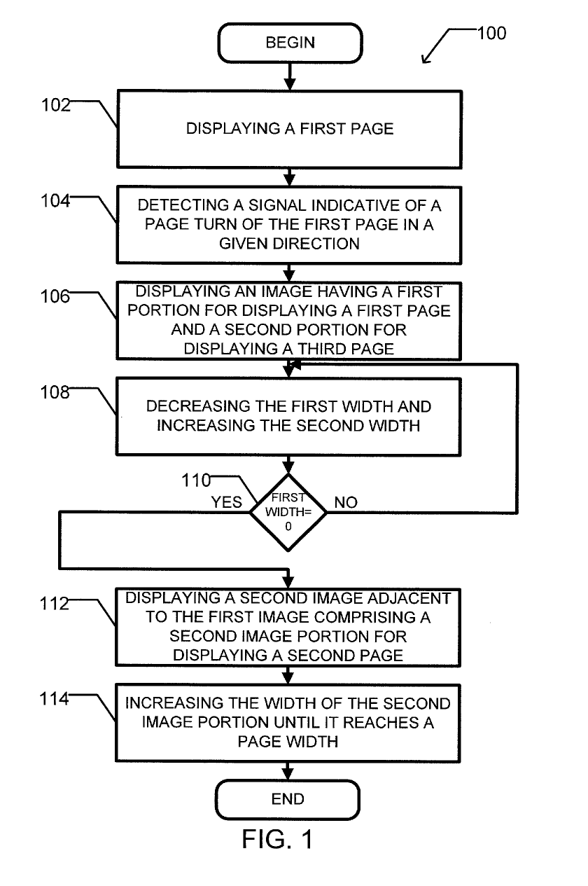

Now referring to FIG. 1, there is shown an embodiment 100 of a method for simulating a page turn in an electronic document comprising a plurality of pages having a given width.

While in one embodiment a page may comprise text such as in a conventional book, it will be appreciated by the skilled addressee that more generally each page of the electronic document may comprise objects selected from a group consisting of texts, images, hyperlinks, animations, videos, etc.

According to processing step 102, a first page of the plurality of pages is displayed.

According to processing step 104, a signal indicative of a page turn of the first page in a given direction is detected.

It will be appreciated that the signal indicative of a page turn of the first page in a given direction may be detected according to various embodiments.

In one embodiment, the signal indicative of a page turn may be a given gesture such as a linear finger movement detected by a touch screen display.

Alternatively, the signal indicative of a page turn may be a given key pressed on a keyboard or any other user interface in an alternative embodiment.

In another embodiment, the signal indicative of a page turn may be provided by another application when given conditions are met.

According to processing step 106, a first image is displayed. The first image has a first portion having a first width and a second portion having a second width substantially smaller than the first width. The first portion comprises the first page while the second portion comprises a selected visible portion of a third page located behind the first page. The selected visible portion of the third page comprises a portion of the third page unmasked by a projection of the first portion of the first page.

According to processing step 108, the first width of the first portion decreases while the width of the second portion increases. Still in this embodiment, the sum of the first width and the second width remains constant.

According to processing step 110, a test is performed in order to find out if the first width is equal to zero. In the case where the first width is not equal to zero and according processing step 108, the first width of the first portion decreases while the width of the second portion increases such that the sum of the first width and the second width remains constant.

In the case where the first width is equal to zero and according to processing step 112, a second image is displayed adjacent to the first image.

In one embodiment the second image comprises a corresponding second image portion having a width substantially smaller than the width of the second portion. The second image is used for displaying a second page of the plurality of pages.

It will be appreciated that in one embodiment, the second image is displayed on the left side of the first image.

According to processing step 114, the width of the corresponding second image portion increases until reaching the given width of the pages.

While a full page turn has been disclosed in FIG. 1, the skilled addressee will appreciate that in one embodiment, a user may decide to interrupt/abort the page turn. In such embodiment, only one part of the method disclosed in FIG. 1 may be performed. In order to implement such embodiment, a user may have to provide an indication of a request for a page turn during the duration of page turn per se so that if the indication of the request is not detected anymore, the page turn stops.

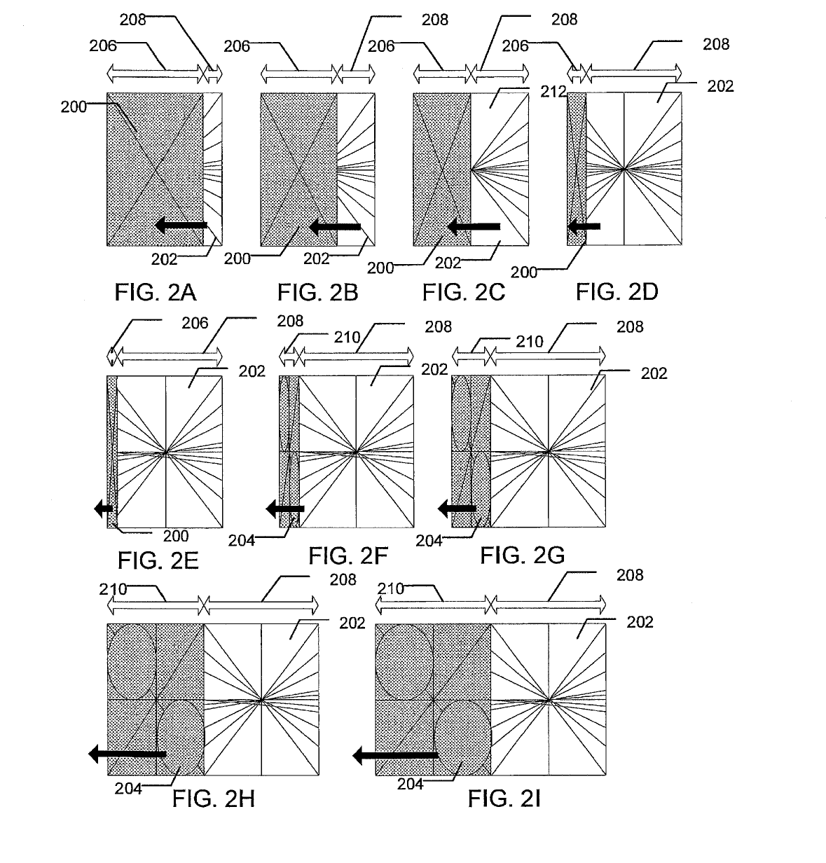

Referring to FIG. 2a, there is shown a first embodiment of a user interface in which a signal indicative of a page turn has been detected.

More precisely and in this embodiment, the user interface comprises a first image having a first portion 200 having a first width 206 and a second portion 202 having a second width 208 substantially smaller than the first width 206. The first portion 200 comprises the first page while the second portion 202 comprises a selected visible portion of a third page located behind the first page. The selected visible portion of the third page is a portion of the third page unmasked by a projection of the first portion of the first page.

FIGS. 2A-2E show embodiments in which the first width 206 decreases while the second width 208 increases. It will be appreciated that that the sum of the first width 206 and the second width 208 remains constant. In a preferred embodiment, the sum is equal to the width of a page.

At one point the first width 206 will be equal to zero and the second width will be equal to the width of the page.

In such case, a second image is displayed adjacent to the first image. Such embodiments are shown in FIGS. 2F-2J.

In one embodiment the second image comprises a corresponding second image portion 204 having a width 210 substantially smaller than the width of the second portion 208. The second image is used for displaying a second page.

It will be appreciated that in one embodiment, the second image is displayed on the left side of the first image in one embodiment.

As shown in FIGS. 2F to 2J, the width 210 of the corresponding second image portion 204 increases until reaching the given width of a page.

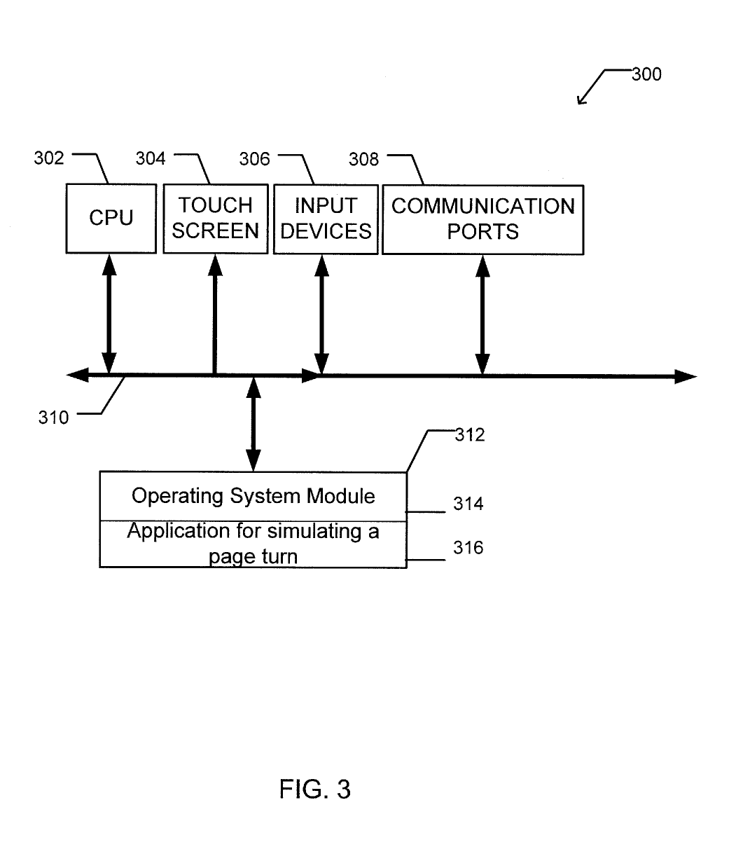

Now referring to FIG. 3, there is shown an embodiment of an apparatus 300 in which an embodiment of the method for simulating a page turn in an electronic document comprising a plurality of pages may be implemented.

The skilled addressee will appreciate that various embodiments may be alternatively provided depending on various considerations departing from the scope of this application.

In this embodiment the apparatus 300 comprises a Central Processing Unit (CPU) 302, a touch screen 304, input devices 306, communication ports 308, a data bus 310 and a memory 312.

The Central Processing Unit 302, the touch screen 304, the input devices 306, the communication ports 308 and the memory 312 are connected together using the data bus 310.

In one embodiment the apparatus 300 is the ExoPC™ manufactured by Pegatron. Still in this embodiment the Central Processing Unit 302 is Atom Pineview-M N450 manufactured by Intel™, running at 1.66 GHz and supporting 64 bits.

Still in this embodiment, the touch screen 304 comprises a touch screen display, an example of which is a touch screen panel having 11.6-inch width and a resolution of 1366×768 pixels with 135 pixels per inch. The touch screen panel uses a multipoint capacitive technology known to the ones skilled in the art. The display device 104 further comprises a GMA500 graphics card manufactured by Intel™.

It will be appreciated that in this embodiment, the touch screen 304 is used by the user to provide the signal indicative of a page turn in a given direction.

The input devices 306 are used for providing data to the apparatus 300.

In this embodiment, the input devices 306 comprise an accelerometer, a microphone, a luminosity sensor and a camera. The skilled addressee will appreciate that various other embodiments for the input devices 306 may alternatively be provided.

The communications ports 308 are used for enabling a communication of the apparatus 300 with other devices.

In this embodiment, the communication ports 308 comprise a WIFI 802.11 b/g/n port, a Bluetooth 2.1+EDR port, two USB 2.0 ports, a SD/SDHC card reader and a mini HDMI port. The skilled addressee will again appreciate that various other embodiments may be provided for the communication ports 308.

The memory 312 is used for storing data.

In this embodiment, the memory 312 comprises a Solid State Drive (SSD) having a capacity of either 32 or 64 GB.

More precisely and still in this embodiment, the memory 312 comprises, inter alia, an operating system module 314. The operating system module 314 is Windows 7™ Home Premium Edition manufactured by Microsoft™.

The memory 312 further comprises an application for simulating a page turn 316. The application for simulating a page turn 316 is used for simulating a page turn in an electronic document comprising a plurality of pages.

More precisely, the application 316 comprises for instance instructions for displaying a first page; instructions for detecting a signal indicative of a page turn of the first page in a given direction; instructions for displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page and instructions for displaying a second image adjacent to the first image when the first width is equal to zero, the second image comprising a corresponding second image portion having a width substantially smaller than the width of the second portion, the second image for displaying a second page, the width of the corresponding second image portion increasing until reaching the given width to thereby simulate a page turn.

The skilled addressee will appreciate that the application may alternatively be embedded in another application such as a document browser or an electronic book reader for instance.

It will be appreciated that in an alternative embodiment, the application for simulating a page turn 316 may be implemented within the operating system module 314.

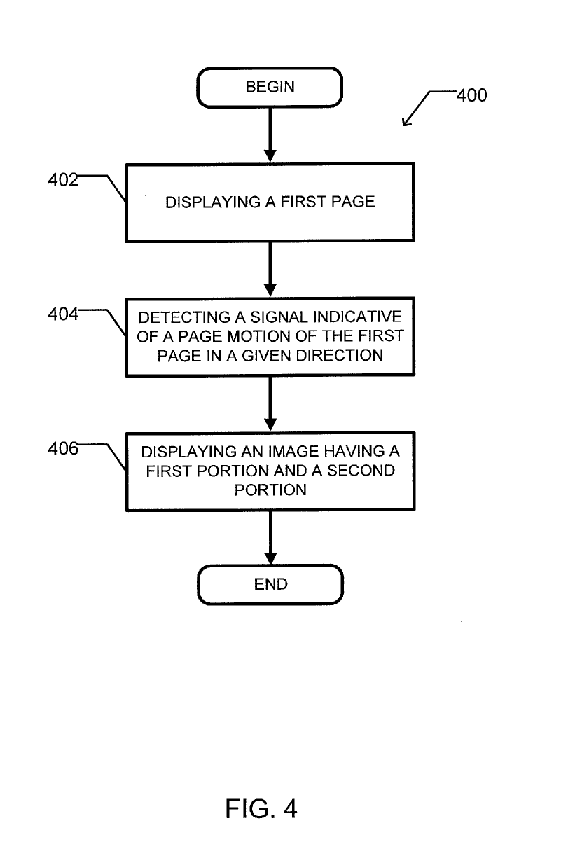

Now referring to FIG. 4, there is shown another embodiment of a method for simulating a page turn in a document comprising a plurality of pages.

According to processing step 402, a first page is displayed.

According to processing step 404, a signal indicative of a page motion of the first page in a given direction is detected.

According to processing step 406, an image is displayed. The image comprises a first portion having a first width and comprises the first page. The second portion has a second width substantially smaller than the first width. The second portion is substantially smaller than the first width and comprises a selected visible portion of a third page located behind the first page.

Still in this embodiment, the width of the first portion decreases while the width of the second portion increases such that the sum of the first width and the second width remains constant. Moreover, the selected visible portion of the third page is a portion of the third page unmasked by a projection of the first portion of the first page.

It will be appreciated that this embodiment is used when the user wishes to do to a page motion and not a full page turn.

It will be appreciated that the embodiment disclosed in FIG. 1 is suitable for a page turn from left to right. The skilled addressee will appreciate that a page turn from right to left may be made without departing from the scope of the present disclosure.

It will be appreciated that the embodiments disclosed above are of great interest.

In particular, it will be appreciated that the embodiments disclosed above provide a realistic way to show a page turn of a page in an electronic document.

Moreover, it will be further appreciated that another advantage of the embodiment disclosed is that it enables the use of limited processing resources compared to prior art embodiments wherein a page curl is computed and generated.

Also, it will be appreciated that a computer-readable storage medium may be provided for storing computer-executable instructions. Such computer-executable instructions would cause a computing device, when executed, to perform a method for simulating a page turn in an electronic document comprising a plurality of pages, the method comprising displaying a first page; detecting a signal indicative of a page turn of the first page in a given direction; displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page; and when the first width is equal to zero, displaying a second image adjacent to the first image, the second image comprising a corresponding second image portion having a width substantially smaller than the width of the second portion, the second image for displaying a second page, the width of the corresponding second image portion increasing until reaching the given width to thereby simulate a page turn.

Although the above description relates to a specific preferred embodiment as presently contemplated by the inventor, it will be understood that the invention in its broad aspect includes functional equivalents of the elements described herein.

1. A method for simulating a page turn in an electronic document comprising a plurality of pages having a given width, the method comprising:
displaying a first page;
detecting a signal indicative of a page turn of the first page in a given direction;
displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page;
when said first width is equal to zero, displaying a second image adjacent to said first image, said second image comprising a corresponding second image portion having a width substantially smaller than the width of the second portion, said second image for displaying a second page, said width of said corresponding second image portion increasing until reaching said given width to thereby simulate a page turn.

2. The method as claimed in claim 1 wherein said signal indicative of a page turn comprises a given gesture.

3. The method as claimed in claim 2, wherein said given gesture comprises a linear finger movement.

4. The method as claimed in claim 1, wherein said signal indicative of a page turn comprises a given key pressed on a keyboard.

5. The method as claimed in claim 1, wherein said signal indicative of a page turn of the first page in a given direction is provided by another application.

6. A method for simulating a page motion in an electronic document comprising a plurality of pages, the method comprising:
displaying a first page;
detecting a signal indicative of a page motion of the first page in a given direction;
displaying an image having a first portion having a first width and comprising the first page and a second portion having a second width substantially smaller than the first width and comprising a selected visible portion of a third page located behind the first page and wherein the width of the first portion decreases while the width of the second portion increases such that the sum of the first width and the second width remains constant and further wherein the selected visible portion of the third page is a portion of the third page unmasked by a projection of the first portion of the first page.

7. The method as claimed in claim 6 wherein said signal indicative of a page motion comprises a given gesture.

8. The method as claimed in claim 7, wherein said given gesture comprises a linear finger movement.

9. The method as claimed in claim 6, wherein said signal indicative of a page motion comprises a given key pressed on a keyboard.

10. The method as claimed in claim 6, wherein said signal indicative of a page motion of the first page in a given direction is provided by another application.

11. A computer-readable storage medium storing computer-executable instructions which, when executed, cause a computing device to perform a method for simulating a page turn in an electronic document comprising a plurality of pages, the method comprising:
displaying a first page;
detecting a signal indicative of a page turn of the first page in a given direction;
displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page;
when said first width is equal to zero, displaying a second image adjacent to said first image, said second image comprising a corresponding second image portion having a width substantially smaller than the width of the second portion, said second image for displaying a second page, said width of said corresponding second image portion increasing until reaching said given width to thereby simulate a page turn.

12. A computing device, comprising:
a display device;
one or more central processing units;
a memory comprising an application; and
one or more programs, wherein the one or more programs are stored in the memory and configured to be executed by the one or more central processing units, the one or more programs including:
instructions for displaying a first page; instructions for detecting a signal indicative of a page turn of the first page in a given direction;
instructions for displaying a first image having a first portion having a first width and comprising the first page and a second portion having a second width substantially smaller than the first width and comprising a selected visible portion of a third page located behind the first page wherein the width of the first portion decreases while the width of the second portion increases such that the sum of the first width and the second width remains constant and further wherein the selected visible portion of the third page is a portion of the third page unmasked by a projection of the first portion of the first page; and
instructions for displaying a second image adjacent to the first image when the first width is equal to zero, the second image comprising a corresponding second image portion having a width substantially smaller than the width of the second portion, the second image for displaying a second page, the width of the corresponding second image portion increasing until reaching the given width to thereby simulate a page turn.

13. A computer-readable storage medium storing computer-executable instructions which, when executed, cause a computing device to perform a method for simulating a page motion in an electronic document comprising a plurality of pages, the method comprising:
displaying a first page;
detecting a signal indicative of a page motion of the first page in a given direction; and
displaying an image having a first portion having a first width and comprising the first page and a second portion having a second width substantially smaller than the first width and comprising a selected visible portion of a third page located behind the first page and wherein the width of the first portion decreases while the width of the second portion increases such that the sum of the first width and the second width remains constant and further wherein the selected visible portion of the third page is a portion of the third page unmasked by a projection of the first portion of the first page.

14. A computing device, comprising:
a display device;
one or more central processing units;
a memory comprising an application; and
one or more programs, wherein the one or more programs are stored in the memory and configured to be executed by the one or more central processing units, the one or more programs including:
instructions for displaying a first page;
instructions for detecting a signal indicative of a page motion of the first page in a given direction; and
instructions for displaying an image having a first portion having a first width and comprising the first page and a second portion having a second width substantially smaller than the first width and comprising a selected visible portion of a third page located behind the first page and wherein the width of the first portion decreases while the width of the second portion increases such that the sum of the first width and the second width remains constant and further wherein the selected visible portion of the third page is a portion of the third page unmasked by a projection of the first portion of the first page.
